(19) United States
(12) Patent Application Publication
(10) Pub. No.: US 2016/0208546 A1
(43) Pub. Date: Jul. 21, 2016

(54) ACTIVE DOOR SEAL AND DOOR ASSEMBLY

(71) Applicant: Therma-Tru Corp., Maumee, OH (US)

(72) Inventors: Seth R. Gillen, Hamilton, IN (US); Jarrod Buffy, Waterville, OH (US)

(21) Appl. No.: 14/995,449

(22) Filed: Jan. 14, 2016

Related U.S. Application Data
(60) Provisional application No. 62/104,162, filed on Jan. 16, 2015.

(51) Int. Cl. E06B 7/23; E06B 1/52; E06B 1/70

(52) U.S. Cl. CPC E06B 7/23; E06B 1/70; E06B 1/52

(57) ABSTRACT

A door assembly including a door frame, a door coupled to the door frame such that the door is pivotable between an open position and a closed position, and a seal attached to one of the door or the door frame for providing a seal between the door and the door frame, wherein the seal has an inactive phase and an active phase providing superior sealing to the inactive phase, and wherein movement of the door from the open position to the closed position results in the seal changing from the inactive phase to the active phase.

### FIELD OF INVENTION

The present invention relates generally to the field of door assemblies and more particularly to door assemblies with an active door seal between the door and door frame.

### BACKGROUND

Doors have been used for centuries to provide and deny access through openings and passageways. A common arrangement is for a door to be pivotably mounted in a door frame by hinges. The door may be provided with a door seal to provide an air tight seal between the door and the door frame. A door seal that provides superior sealing performance while also allowing the door to move easily is desirable.

### SUMMARY

The present patent application discloses exemplary embodiments of door assemblies. In an exemplary embodiment, the door assembly includes a door frame, a door coupled to the door frame such that the door is pivotable between an open position and a closed position, and a seal attached to one of the door or the door frame for providing a seal between the door and the door frame, wherein the seal has an inactive phase and an active phase providing superior sealing to the inactive phase, and wherein movement of the door from the open position to the closed position results in the seal changing from the inactive phase to the active phase.

In another exemplary embodiment, the door assembly may include a door frame, a door, and a seal. The door frame may include a first side section, a second side section, and a sill section connecting the first section to the second side section. The door may be coupled to the second side section such that the door is pivotable between an open position and a closed position. The door may include a first edge surface, a second edge surface, and a third edge surface connecting the first edge surface to the second edge surface. The seal may be attached to one of the door or the door frame and include a first portion, a second portion, and a third portion wherein movement of the door from the open position to the closed position, compresses the first portion causing expansion of the second portion and the third portion.

### BRIEF DESCRIPTION OF THE SEVERAL VIEWS OF THE DRAWINGS

The accompanying drawings, which are incorporated in and constitute a part of this specification, illustrate some embodiments disclosed herein, and together with the description, serve to explain principles of the embodiments disclosed herein.

FIG. 1 is a perspective view of an exemplary embodiment of a door assembly with the door in an open position;

FIG. 2 is a front view of the door assembly of FIG. 1 with the door in a closed position;

FIG. 3 is a perspective view of an exemplary embodiment of a seal for the door assembly of FIG. 1;

FIG. 4 is a cross-section view of a first portion of the seal of FIG. 3;

FIG. 5 is a cross-section view of a second portion of the seal of FIG. 3;

FIG. 6 is a cross-section view of a third portion of the seal of FIG. 3;

FIG. 7 is a perspective view of an exemplary embodiment of a seal for the door assembly of FIG. 1;

FIG. 8 is a side view of the seal of FIG. 7;

FIG. 9 is a cross-section view of a first portion of the seal of FIG. 7 sectioned along the B-B line;

FIG. 10 is a cross-section view of a second portion of the seal of FIG. 7 sectioned along the C-C line; and

FIG. 11 is a cross-section view of a third portion of the seal of FIG. 7 sectioned along the A-A line.

### DETAILED DESCRIPTION

The embodiments disclosed herein will now be described by reference to some more detailed embodiments, in view of the accompanying drawings. These embodiments may, however, be embodied in different forms and should not be construed as limited to the embodiments set forth herein. Rather, these embodiments are provided so that this disclosure will be thorough and complete, and will fully convey the scope of the inventions to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise. All publications, patent applications, patents, and other references mentioned herein are incorporated by reference in their entirety.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

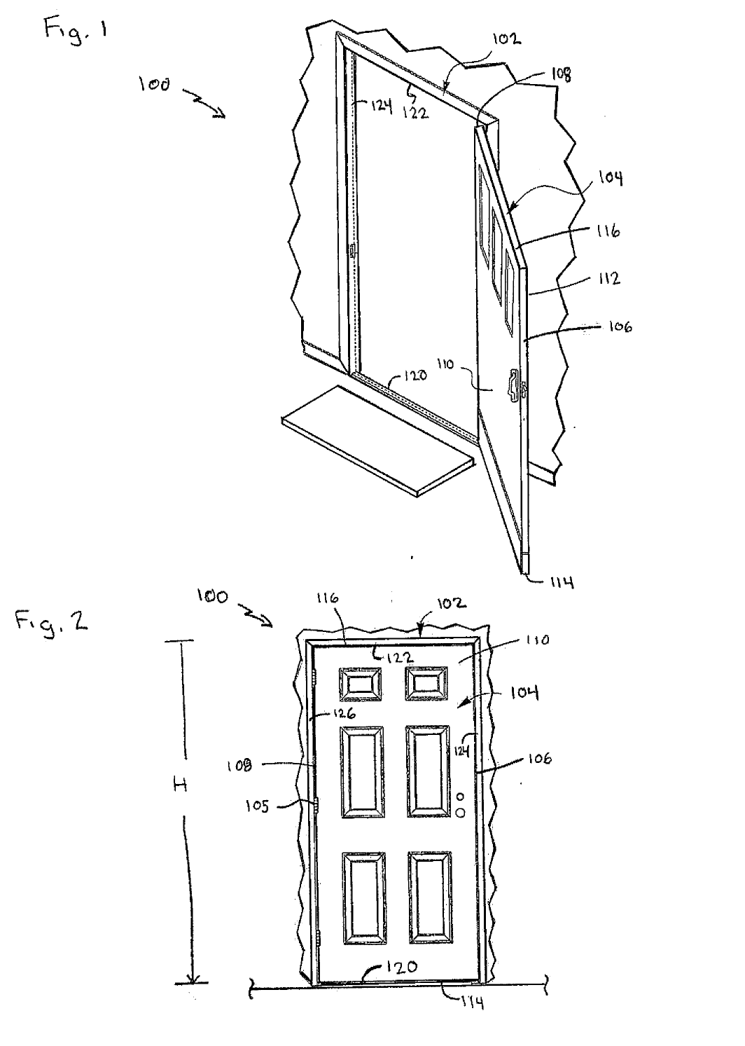

FIGS. 1 and 2 illustrate an exemplary embodiment of a door assembly 100 including a door frame 102 and a door 104 that is connected to the frame such that the door is pivotable between an open position (FIG. 1) and a closed position (FIG. 2). The door assembly 100 may take a wide variety of different forms and be used in a variety of applications. For example, in an exemplary embodiment, the door is a residential building door, such as an entrance door of a house. Further, the shape and size of the door and the door frame may vary in different embodiments. Any suitable shaped and sized door and frame may be used. The door 104 may be pivotably connected to the door frame in a wide variety of ways, such as for example, conventional door hinges 105.

In the exemplary embodiment of FIGS. 1 and 2, the door 104 includes a first edge surface 106, a second edge surface 108 spaced apart from and parallel to the first edge surface, a first face surface 110 that extends from the first edge surface to the second edge surface, a second face surface 112 that is opposed to and spaced apart from the first face surface and extends from the first edge surface to the second edge surface, a third edge surface 114 that is perpendicular to and extends between the first edge surface and the second edge surface, and a fourth edge surface 116 that is parallel to and spaced apart from the third edge surface and that extends between the first edge surface and the second edge surface.

The door frame 102 is shaped complimentary to the door 104 in that it closely surrounds the periphery of the door. The door frame 102 includes a sill section 120, a top section 122 spaced part from and parallel to the sill section, a first side section 124 that is perpendicular to and extends between the sill section and the top section, and a second side section 126 that is spaced apart from and parallel to the first side section and that is perpendicular to and extends between the sill section and the top section. Any one or more of the door frame sections may also include additional accessories. For example, the door frame 102 may include jamb stops, a trim piece, such as a brick molding, that hides the interface between a wall and the door frame, a frame extending component, such as a screen door adapter or track, or a sill extending component, such as a sill extender that attaches to the sill to cover a larger rough frame member.

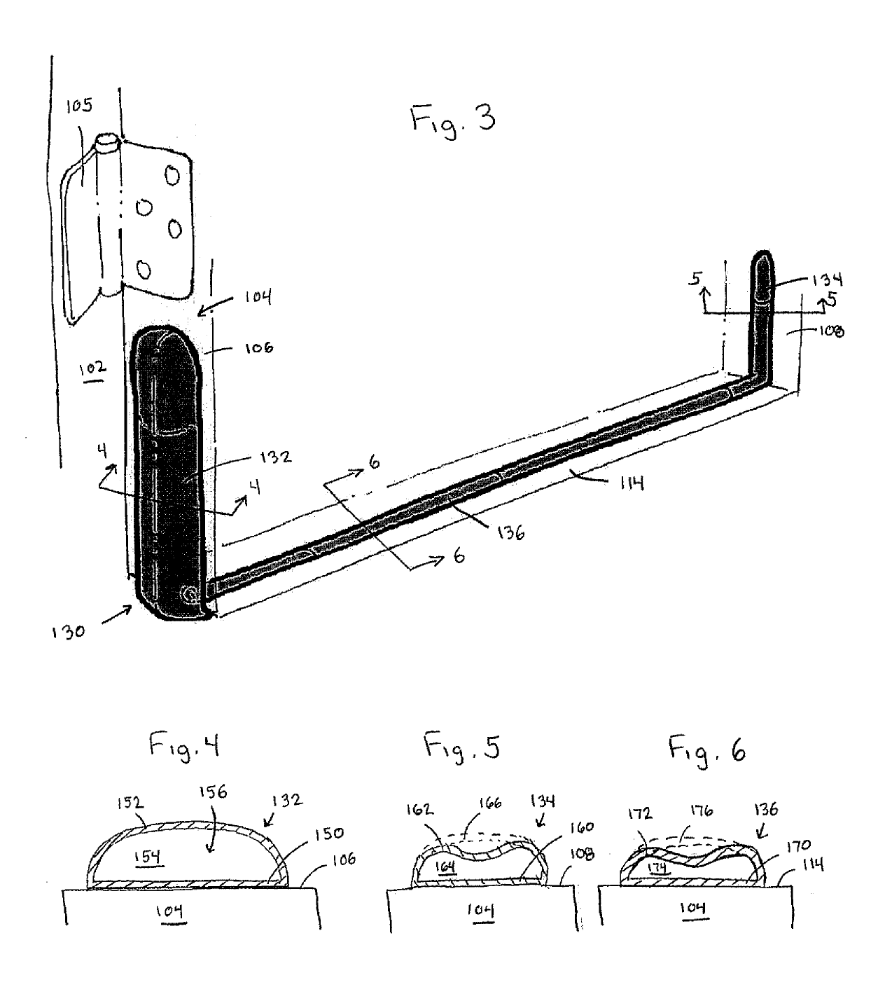

Referring to FIG. 3, the door assembly 100 includes one or more active seals 130 for providing a seal between the door frame 102 and the door 104 when the door is in the closed position (FIG. 2). For the purpose of this disclosure, an active seal is a seal that can change between an active sealing mode and an inactive sealing mode. While the inactive sealing mode may still provide some sealing performance, the active sealing mode provides superior sealing performance to the inactive sealing mode. The one or more active seals 130 may be configured in a variety of ways. For example, the one or more seals 130 may be attached to the door frame 102, to the door 104, or seals may be attached to both. The one or more seals 130 may extend around the entire periphery of the door 104 between the door and the door frame 102 when the door is closed or may only extend around a portion of the periphery. The number, shape and size of the seals 130 may vary in different embodiments and may vary between different portions of each seal. In the exemplary embodiment of FIGS. 3-6, the seal 130 has a single-piece body that is attached to the door 104. In other embodiments, however, multiple seals may be used or one or more seals that include multiple pieces attached together may be used. As shown in FIG. 3, the seal 130 includes a first portion 132 attached to and extending along at least a portion of the first edge surface 106, a second portion 134 attached to and extending along a portion of the second edge surface 108, and a third portion 136 attached to and extending along the entire length of the third edge surface 114.

In the exemplary embodiment, the first portion 132 and the second portion 134 extend less than half of the height H (FIG. 2) of the first edge surface 106 and the second edge surface 108, respectively. In one exemplary embodiment, the first portion 132 and the second portion 134 extend in the range of two inches to four inches, or about two to four inches, from the third edge surface 110 up the first edge surface 106 and the second edge surface 108, respectively. In other embodiments, however, the first portion 132 and the second portion 134 may extend more than four inches or less than two inches up the first edge surface 106 and the second edge surface 108, respectively. The first portion 132 and the second portion 134 may extend the same distance up the first edge surface 106 and the second edge surface 108, respectively, or may extend different distances. The seal 130 may be attached to the door 104 by any suitable means, such as for example, by an adhesive, staples, interference fit, or other suitable attachment.

The cross-sectional shape of the seal 130 may vary in different embodiment and across different portions of the seal. For example, the cross-sectional shape in the first portion 132 may differ from the cross-sectional shape in the second portion 134 or the third portion 136.

Referring to FIG. 4, in the exemplary embodiment, the first portion 132 has a generally semicircular cross-sectional shape when the door is in the open position. In other embodiments, however, the cross sectional shape of the first portion 132 can be other than semicircular. The first portion 132 includes a planar first side wall 150 and a curved second side wall 152. The first side wall 150 is adapted to attach to the first edge surface 106 of the door 104. The first side wall 150 and the second side wall 152 form an internal cavity 154 that may be filled with a fluid (such as a liquid or gas) or a gel 156. The internal cavity 154 has a volume V1 when the door 104 is in the open position.

The first portion 132 may be made from a variety of materials. Any material or materials capable of allowing the volume V1 of the internal cavity to be changed by compression or expansion may be used. Suitable materials may include, but not be limited to, one or more rubber materials, such as for example, neoprene, silicone, and butyl rubbers. The fluid or gel may be any suitable fluid or gel. Any fluid or gel capable of flowing from the first portion when the first portion is compressed into the second portion and third portion to expand the second and third portions may be used.

Referring to FIG. 5, the second portion 134 includes a planar first side wall 160 and a flexible second wall 162. The first side wall 160 is adapted to attach to the second edge surface 108 of the door 104. The first side wall 160 and the second side wall 162 form an internal cavity 164 that has a volume V2 when the door 104 is in the open position. The cross sectional shape of the second portion 134 when the door 104 is in the open position may vary since the second wall 162 is flexible. When fluid or gel, such as the fluid or gel 156 from the internal cavity 154 of the first portion 132, fills the internal cavity 164 of the second portion 134, the cross-sectional shape of the second portion expands and becomes semi-circular, or generally semi-circular (as illustrated by dashed lines 166 in FIG. 5). The volume V2 of the second portion 134 when the door 104 is in the open position is less than the volume V1 of the first portion when the door 104 is in the open position.

The second portion 134 may be made from a variety of materials. Any material or materials capable of allowing the volume of the internal cavity 164 to be changed by compression or expansion may be used. For example, the material may be one or more materials used in the first portion 132 or may be a different material. In addition, first side wall 160 may be made of a different material than the flexible second wall 162. For example, the flexible second wall 160 may be made from a material selected for its elastic properties while the material first side wall may be selected for its strength and ease of attachment to the door 104.

Referring to FIG. 6, the third portion 136 may be configured the same or substantially the same as the second portion 134 in that the third portion includes a planar first side wall 170 and a flexible second wall 172. The first side wall 170 is adapted to attach to the third edge surface 114 of the door 104. The first side wall 170 and the second side wall 172 form an internal cavity 174 that has a volume V3 when the door 104 is in the open position. The cross sectional shape of the second portion 134 when the door 104 is in the open position may vary since the second wall 172 is flexible. When fluid or gel, such as the fluid or gel 156 from the internal cavity 154 of the first portion 132, fills the internal cavity 174 of the third portion 136, the cross-sectional shape of the third portion expands and becomes semi-circular, or generally semi-circular (as illustrated by dashed line 176 in FIG. 6).

The third portion 136 may be made from a variety of materials. Any material or materials capable of allowing the volume of the internal cavity 164 to be changed by compression or expansion may be used. For example, the material may be one or more materials used in the first portion 132 or the second portion 134 or may be a different material. In the exemplary embodiment, the third portion 136 is made from the same material as the second portion 134.

In operation, the second portion 134 and the third portion 136 expand when the door 104 moves from the open position to the closed position to provide a superior seal between the door 104 and the door frame 102 than would be provided without the seal expanding. In particular, the seal 130 is in an inactive state when the door 104 is in an open position. In an inactive state, the internal cavity 154 of the first portion 132 is filled by the fluid or gel 156. When the door 104 approaches the closed position, the first portion 132 is compressed between the first side section 124 of the door frame 102 and first edge surface 106 of the door 104.

As the first portion 132 is compressed, the volume V1 of the first portion internal cavity 154 decreases. Since the first portion internal cavity 154 is in fluid communication with the internal cavity 164 of the second portion 134 and the internal cavity 174 of the third portion 136, the fluid or gel 156 in the first portion internal cavity 154 is forced into the second portion internal cavity 164 and the third portion internal cavity 174. As a result, the volume V2 of the second portion internal cavity 164 increases and the volume V3 of third portion internal cavity 174 increases. Thus, the second and third portions 134, 136 expand while the first portion 132 compresses, resulting in improved sealing between the sill section 120 of the door frame 102 and the third edge surface 114 of the door 104 and between the second side section 126 of the door frame and the second edge surface 108 of the door 104. Some fluid or gel 156, however, remains in the first portion 132 when the door is closed such that the first portion provides an adequate seal between the first side section 124 of the door frame and the first edge surface 106 of the door 104.

When the door 104 moves from the closed position to the open position, the release of pressure on the first portion 132 due to the first edge surface 106 pivoting away from the first side section 124 results in the fluid or gel 156 flowing back into the first portion internal cavity 154 from the second portion internal cavity 164 and the third portion internal cavity 174. As a result, the second portion 134 and the third portion 136 return to their unexpanded size and the door 104 is able to pivot more easily.

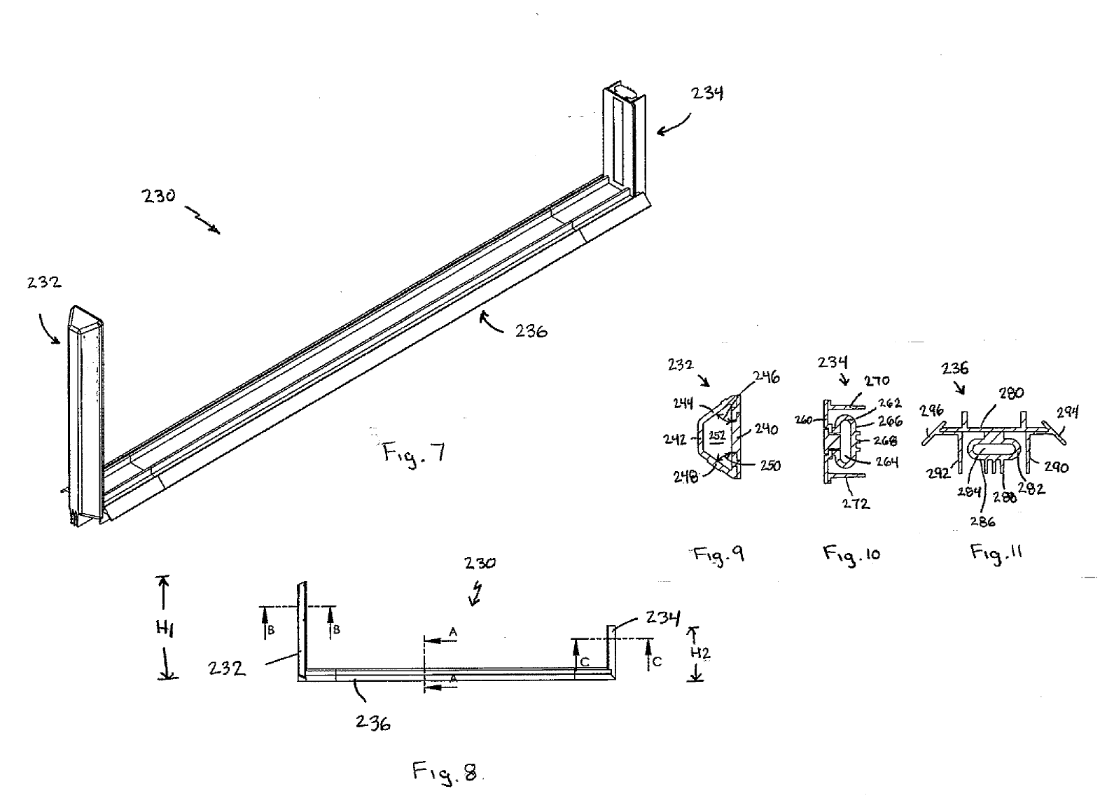

FIGS. 7-11 illustrate another exemplary embodiment of a seal 230 for the door assembly 100 of FIGS. 1-2. Similar to seal 130 of FIGS. 3-6, the seal 230 includes a first portion 232, a second portion 234, and a third portion 236. In the exemplary embodiment, the first portion 232 and the second portion 234 extend less than half of the height H of the first edge surface 106 and the second edge surface 108, respectively (FIG. 2). In one exemplary embodiment, the first portion 232 and the second portion 234 extend in the range of two inches to four inches, or about two to four inches, from the third edge surface 110 up the first edge surface 106 and the second edge surface 108, respectively. In other embodiments, however, the first portion 232 and the second portion 234 may extend more than four inches or less than two inches up the first edge surface 106 and the second edge surface 108, respectively. The first portion 232 and the second portion 234 may extend the same distance up the first edge surface 106 and the second edge surface 108, respectively, or may extend different distances. In the exemplary embodiment of FIGS. 7 and 8, the first portion 232 has a height H1 and the second portion 234 has a height H2. The height H1 of the first portion 232 is twice, or about twice, the height H2 of the second portion 234. In other embodiments, however, the height H1 of the first portion 232 may be more or less than twice the height H2 of the second portion 234. The seal 230 may be attached to the door 104 by any suitable means, such as for example, by an adhesive, interference fit, staples, or other suitable methods of attachment.

Referring to FIG. 9, the first portion 232 has a generally hollow, trapezoidal cross-section. In other embodiments, however, the cross sectional shape of the first portion 232 can be other than trapezoidal. The first portion 232 includes a first side wall 240 configured to attach to the first edge surface 106, a second side wall 242 spaced apart from and generally parallel to the first side wall, a third side wall 244 extending between the first side wall and the second side wall at a first angle 246, and a fourth side wall 248 spaced apart from the third side wall and extending between the first side wall and the second side wall at a second angle 250. The first portion 232 may be formed as a single piece, or may be multiple pieces attached together. For example, one or more of the side walls, 240, 242, 244, 246 may be a separate piece attached to one or more of the other side walls to form the first portion 232. Furthermore, one or more of the side walls, 240, 242, 244, 246 may be a single piece or may include multiple pieces attached together.

The walls form an internal cavity 252 that may be filled with a fluid (such as a liquid or gas) or gel. The internal cavity 252 has a volume V1 when the door is in the open position. The first portion 242 may be made from a variety of materials. Any material or materials capable of allowing the volume V1 of the internal cavity to be changed by compression or expansion may be used. Suitable materials may include, but not be limited to, one or more rubbers such as for example, neoprene, silicone, and butyl rubbers.

Referring to FIG. 10, in the exemplary embodiment, the second portion 234 includes a first side wall 260 configured to attach to the second edge surface 108, a second wall 262 extending from the first side wall 260 to form an oval shaped internal cavity 264 having a volume V2 when the door is in the open position. In other exemplary embodiments, however, the internal cavity 264 may be other than oval shaped. The internal cavity 264 is in fluid communication with the internal cavity 252 of the first portion 232.

The second side wall 262 has an outer surface 266 facing away from the cavity 264. In the exemplary embodiment, the outer surface 266 includes one or more projections 268 for engaging the door frame 102 to improve sealing between the door frame and the door 104. In other embodiments, however, the outer surface 266 may not have any projections for engaging the door frame 102. In the exemplary embodiment, the one or more projections 268 are formed as a plurality of flexible fingers extending outward from the outer surface 266.

The second portion 234 also includes a first fin 270 extending outward from the first side wall 260 along one side of the internal cavity 264 and a second fin 272 spaced apart from and parallel to the first fin 270 extending outward from the first side wall 260 along the opposite side of the internal cavity 264. In one embodiment, the first fin 270 and the second fin 272 are flexible and extend outward to engage the door frame 102 to improve sealing between the door frame and the door 104.

The second portion 234 may be made from a variety of materials. Any material or materials capable of allowing the volume V2 of the internal cavity 264 to be changed by compression or expansion and to allow the projection and fins to be flexible to form a seal against the door frame may be used. For example, the material may be a material used in the first portion 232 or may be a different material. In addition, the second portion 234 may be made from a single material or made be made from multiple materials. For example, the second wall 262 may be made from a material selected for its elastic properties to allow the internal cavity 264 to expand while the projections 268 and the fins 270 may be made from a material selected for flexibility to allow the projections and fins to flex when engaging the door frame 102 and also for durability since the projections and fins will be in sliding engagement with the door frame. The second portion 234 may be formed as a single piece, or may be multiple pieces attached together.

Referring to FIG. 11, in the exemplary embodiment, the third portion 236 includes a first side wall 280 configured to attach to the second edge surface 108, a second wall 282 extending from the first side wall 280 to form an oval shaped internal cavity 284 having a volume V3 when the door is in the open position. In other exemplary embodiments, however, the internal cavity 284 may be other than oval shaped. The internal cavity 284 is in fluid communication with the internal cavity 252 of the first portion 232.

The second side wall 282 has an outer surface 286 facing away from the cavity 284. In the exemplary embodiment, the outer surface 286 includes one or more projections 288 for engaging the door frame 102 to improve sealing between the door frame and the door 104. In other embodiments, however, the outer surface 286 may not have any projections for engaging the door frame 102. In the exemplary embodiment, the one or more projections 288 are formed as a plurality of flexible fingers extending outward from the outer surface 286.

The third portion 236 also includes a first fin 290 extending outward from the first side wall 280 along one side of the internal cavity 284 and a second fin 292 spaced apart from and parallel to the first fin 290 extending outward from the first side wall 280 along the opposite side of the internal cavity 284. The first fin 290 and the second fin 292 extend outward to engage the door frame 102 to improve sealing between the door frame and the door 104. The third portion also includes a third fin 294 extending outward from the first side wall 280 traverse to the first fin 290 and a fourth fin 296 spaced apart from the third fin 294 and extending outward from the first side wall 280 traverse to the second fin 292. In one embodiment, the first fin 290, the second fin 292, the third fin 294, and the fourth fin 296 are flexible and engage portions of the door frame or additional accessories attached to the frame to improve sealing between the door frame and the door 104.

The third portion 236 may be made from a variety of materials. Any material or materials capable of allowing the internal cavity's volume to be changed by compression or expansion and to allow the projection and fins to be flexible to form a seal against the door frame may be used. For example, the material may be a material used in the first or second portions 232, 234 or may be a different material. In addition, the third portion 236 may be made from a single material or made be made from multiple materials. The third portion 236 may be formed as a single piece, or may be multiple pieces attached together.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to any particular door assembly application. Furthermore, although various embodiments are described in detail, in view of the accompanying drawings, those skilled in the art will understand that aspects and elements of one exemplary embodiment can be used or modified for use with other embodiments and should not be construed as limited to the embodiments set forth herein. It is sought, therefore, to cover all such changes and modifications as fall within the spirit and scope of the general inventive concepts, as described and claimed herein, and equivalents thereof.

1. A door assembly, comprising:
a door frame including a first side section, a second side section, and a sill section connecting the first section to the second side section;
a door coupled to the first side section such that the door is pivotable between an open position and a closed position, the door including a first edge surface, a second edge surface, and a third edge surface connecting the first edge surface to the second edge surface;
a seal attached to one of the door or the door frame, the seal having a first portion, a second portion, and the third portion;
wherein movement of the door from the open position to the closed position, compresses the first portion causing expansion of the second portion and the third portion.

2. The door assembly of claim 1 wherein the seal is attached to the first edge surface, the second edge surface, and the third edge surface.

3. The door assembly of claim 1 wherein the first portion of the seal is attached to the first edge surface, the second portion of the seal is attached to the second edge surface, and the third portion of the seal is attached to the third edge surface.

4. The door assembly of claim 1 wherein the first portion of the seal extends along less than half of the height of the first edge surface, the second portion of the seal extends along less than half of the height of the second edge surface and the third portion of the seal extends along the entire length of the third edge surface.

5. The door assembly of claim 1 wherein the first portion has a first height and the second portion has a second height, and wherein the first height is greater than the second height.

6. The door assembly of claim 1 wherein the first portion is compressible and includes an internal cavity in fluid communication with an internal cavity in the second portion and an internal cavity in the third portion, wherein compression of the first portion transfers fluid or gel into the second and third portions.

7. The door assembly of claim 6 wherein the second portion and the third portion are expandable.

8. The door assembly of claim 1 wherein the first portion has a first cross-sectional shape when the door is in the open position and the second portion has a second cross-sectional shape when the door is in the open position, wherein the first cross-sectional shape is different than the second cross-sectional shape.

9. The door assembly of claim 1 wherein the first cross-sectional shape is semicircular or trapezoidal.

10. A seal for a door assembly, comprising:
a compressible first portion;
a second portion extending traverse to the first portion when installed on the door assembly, the second portion being expandable;
a third portion extending traverse to the second portion when installed on the door assembly, the third portion being expandable;
wherein compression of the first portion causes expansion of the second portion and the third portion.

11. The seal of claim 10 further comprising a first internal cavity in the first portion, a second internal cavity in the second portion that is in fluid communication with the first internal cavity, and a third internal cavity in the third portion that is in fluid communication with the first internal cavity, wherein the first internal cavity contains a fluid or gel, and wherein compression of the first internal cavity forces at least some of the fluid or gel into the second internal cavity and a third internal cavity.

12. The seal of claim 11 wherein the volume of the first internal cavity is greater than the volume of the second internal cavity.

13. The seal of claim 11 wherein the first internal cavity is trapezoidal or semicircular in shape.

14. The seal of claim 11 wherein the second internal cavity is oval in shape.

15. The seal of claim 11 wherein the second portion includes an outer surface and one or more flexible projections extending from the outer surface for engaging a door or a door frame of the door assembly.

16. A method of providing a seal between a door and a door frame, comprising:
providing a seal on one of the door or the door frame;
moving the door from an open position to a closed position compressing a first portion of the seal in response to moving the door to the closed position; and
expanding a second portion of the seal in response to compressing the first portion of the seal, wherein expanding the second portion seals a space between the door and door frame.

17. The method of claim 16 wherein expanding the second portion of the seal in response to compressing the first portion of the seal includes transferring a fluid or gel from the first portion to the second portion.

18. A door assembly, comprising:
a door frame;
a door coupled to the door frame such that the door is pivotable between an open position and a closed position;
a seal attached to one of the door or the door frame for providing a seal between the door and the door frame, the seal having an inactive phase and an active phase, the active phase providing superior sealing to the inactive phase;
wherein movement of the door from the open position to the closed position results in the seal changing from the inactive phase to the active phase.
